(19) United States
(12) Patent Application Publication
(10) Pub. No.: US 2007/0104112 A1
(43) Pub. Date: May 10, 2007

(54) Systems and techniques for establishing a connection over a network

(76) Inventors: Craig Peter Sayers, Menlo Park, CA (US); Evan Randy Kirshenbaum, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/267,532

(22) Filed: Nov. 4, 2005

(51) Int. Cl. H04J 1/16

(52) U.S. Cl. 370/252; 370/338

(57) ABSTRACT

Provided are systems and techniques for connecting first and second devices over a network by utilizing a small, portable third device to carry network connection information from one of the devices to the other. In one representative implementation, the portable device functions as a sort of virtual cable, in that plugging it into one of the first and second devices causes a connection to be established with the other.

### FIELD OF THE INVENTION

The present invention pertains to systems and techniques for establishing a connection over a network, such as a local-area computer network, a wide-area computer network, a wireless network or the Internet.

### BACKGROUND

In the field of computing, it is increasingly desirable to connect a computer to a peripheral device, such as a printer or scanner, or to another computer. Such connections typically can be made directly with the use of a parallel or universal serial bus (USB) cable. Alternatively, if both devices are on the same local area network (LAN) the computer can be configured to access such other device, provided that it has appropriate permissions. While such a network connection sometimes can be cumbersome to initially configure, once the configuration is made the computer generally can access the device at any time. For example, a computer user can print to any available printer on the network by simply selecting the desired printer in his or her printer folder.

Conventionally, very few other options exist for connecting devices to each other. The use of a direct cable is perhaps the simplest method for connecting to devices. However, such connections are limited in terms of how far apart the two devices can be. At the very least, that distance is limited to the length of the cable that is used. In addition, there often are technological limitations, depending upon the connection protocol, that limit how long a cable can be while still providing adequate signal strength.

Use of a network permits devices to be geographically distant from each other, as well as allowing peripheral devices to be shared among the number of different computers and even allowing different computers to communicate with each other and/or with central servers. However, there are significant limitations with a conventional network.

For instance, when a network reaches a certain size, the sheer number of connected devices can make use of the system cumbersome. For example, a user might have only a couple of printers that he or she uses on a regular basis, but occasionally needs to access another printer on the network. In such a case, the network administrator will want to make all printers available to the user, rather than only the ones that are commonly used, in order to accommodate the special case. However, when presented with a large list of available printers, it often will be difficult for the user to locate the specific printer that he or she wishes to use.

Also, there typically is no simple way to connect two devices that are not present on the user's own LAN, or on a LAN to which the user currently has access. Nevertheless, users sometimes need or would like to have access to devices at off-site locations. Similarly, users sometimes travel to clients' sites or other off-site locations and would like to have access to computers or personal devices back at their offices.

Finally, shared input devices, such as walk-up scanners present a special problem. These types of devices frequently have very limited user interfaces and, accordingly, even if they are present on the user's own LAN, it often is cumbersome for the user to designate the device to which the input data should be sent.

As to this last problem, a couple of solutions have been proposed. Some walk-up scanners (such as the scanning attachment to the HP 4200 printer) allow the user to select a user from a list of all users on the network, and the scan job is e-mailed to the selected user.

Another approach, employed by the AccuRoute document management product sold by OmTool, allows the user to design routing instructions and then print out a cover sheet containing or referencing such instructions. For example, the routing instructions might direct storing the document at a particular location, printing it at a particular location, e-mailing it to one group of people and faxing it to another. Later, when the cover sheet is scanned along with the rest of the scan job, the routing instructions on it are read by the software and automatically implemented by the system.

In the FlowPort document management software, users are allowed to print a form with headings and checkboxes. Later, the actual distribution can be selected by checking boxes corresponding to desired recipients or destinations.

### BRIEF DESCRIPTION OF THE DRAWINGS

FIGS. 1A-C are block diagrams showing an implementation of a technique, according to a representative embodiment of the invention, for connecting two electronic devices over a network.

FIG. 2 is a flow diagram for explaining a technique for connecting two electronic devices over a network, according to a representative embodiment of the present invention.

FIG. 3 illustrates a perspective view of a small portable device for storing network connection information according to a representative embodiment of the present invention.

FIG. 4 is a block diagram showing the internal structure of a computer or peripheral that may be connected to another device in accordance with representative embodiments of the invention.

FIG. 5 is a block diagram of the small portable device shown in FIG. 3, according to a representative embodiment of the present invention.

FIG. 6 illustrates a perspective view of a small portable device for storing network connection information according to an alternate embodiment of the present invention.

FIG. 7 illustrates a side elevational view of the device depicted in FIG. 6.

FIG. 8 is a block diagram of a small portable device for storing network connection information, according to a still further embodiment of the present invention.

FIG. 9 is a flow diagram for explaining storage of network connection information according to a representative embodiment of the present invention.

FIG. 10 is a flow diagram for explaining in more detail how a network connection is established according to a representative embodiment of the present invention.

### DESCRIPTION OF THE PREFERRED EMBODIMENT(S)

The present invention utilizes a small portable electronic device to store information for establishing a network connection with one or more devices, rather than using a sheet of paper with routing instructions on it. According to one particular embodiment of the present invention, described in more detail below, the small portable electronic device plugs into a computer or a peripheral device and functions as a sort of virtual cable between two electronic devices.

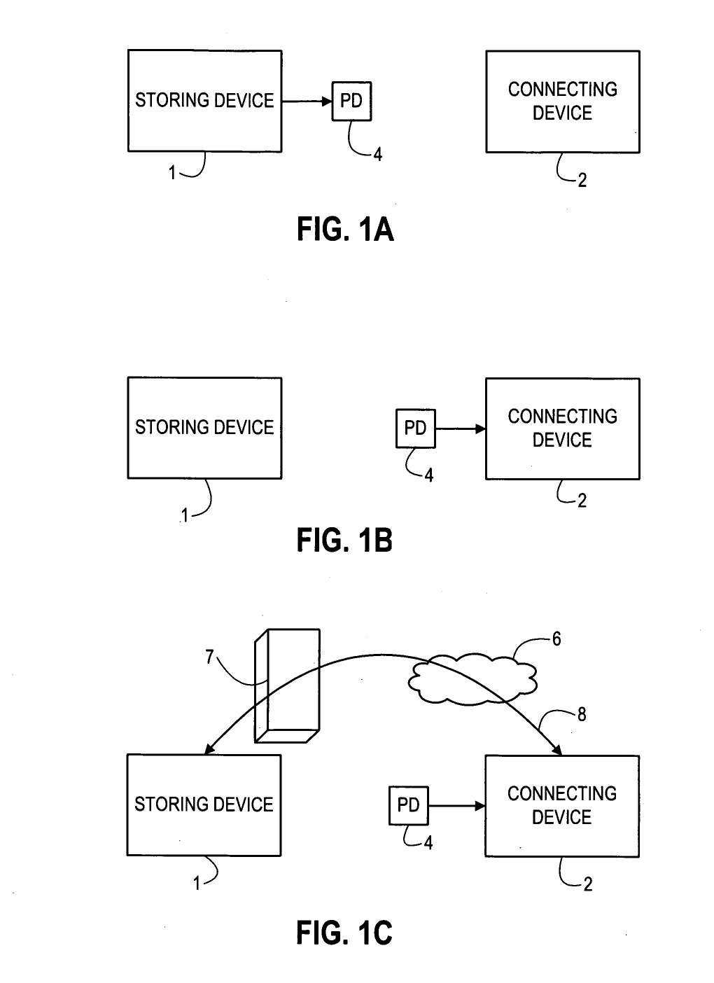

The basic concept behind certain representative embodiments of the invention is now described with reference to FIGS. 1A-C and 2. Initially, referring to FIGS. 1A-C, the present invention addresses the problem of how to connect two different devices 1 and 2, each of which comprising any type of networked device, such as a general-purpose computer (e.g., a desktop or laptop) or a peripheral device (e.g., a printer or scanner). For purposes that will become apparent below, with respect to the present embodiment of the invention device 1 is referred to as the “storing device” and device 2 is referred to as the “connecting device”. However, it is also to be understood that any particular device may function at one time as a storing device 1 and at another time as a connecting device 2.

As noted above, the simplest way to connect devices 1 and 2 would be to use a direct cable connection. For practical reasons, however, this is not always possible. At the same time, devices 1 and 2 typically already will be capable of communicating with each other, at least in theory, because they either will be connected to the same local-area network (LAN) or wide-area network (WAN), or because each will be connected to the Internet (either directly or through another network or series of networks). In order to permit such a connection, however, certain information has to be exchanged between the two devices and, in some cases, appropriate settings will have to be made at each end.

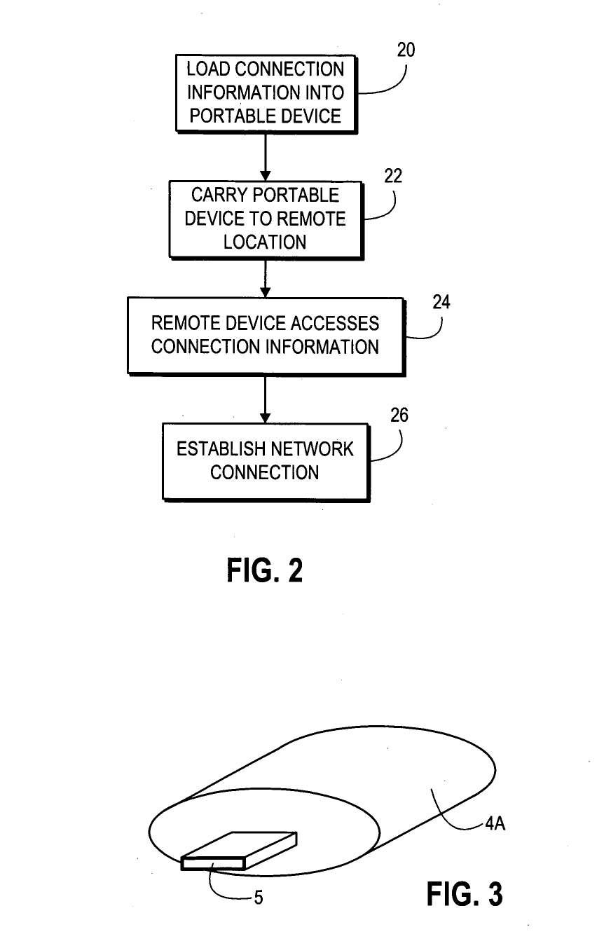

An overview of a technique according to the present invention for accomplishing this is now described. The individual steps described below are illustrated in FIG. 2, and the referenced system components are illustrated in FIGS. 1A-C.

Initially, in step 20 storing device 1 loads certain connection parameters and other connection information into a small portable electronic device 4. Preferably, device 4 is a hand-sized device that may be easily carried by a user from one location to another. More preferably, device 4 is configured as a small USB memory device (i.e., whose longest dimension is no more than a couple of inches). One example is device 4A shown in FIG. 3, whose USB connector 5 simply may be plugged into storing device 1. However, in alternate embodiments, described in more detail below, device 4 has any of a number of different configurations.

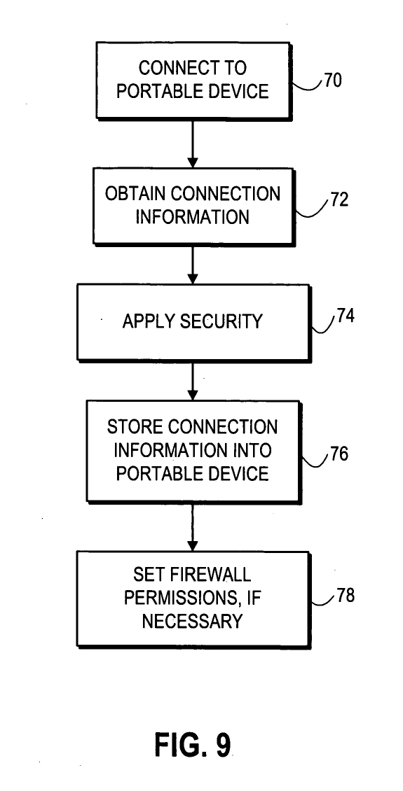

In any event, in the preferred embodiments of the invention, adequate information is loaded into device 4 so as to permit an external device to access storing device 1 from any arbitrary location, including any information necessary to get through any existing firewalls. As used herein, a firewall refers to any software or product that is configured to limit access. A more detailed description of this step 20 is provided below in connection with the discussion of FIG. 9.

Next, in step 22 portable device 4 is carried by the user to a remote location. This may be a location in the same office building as where storing device 1 is located, or it may be an entirely different location.

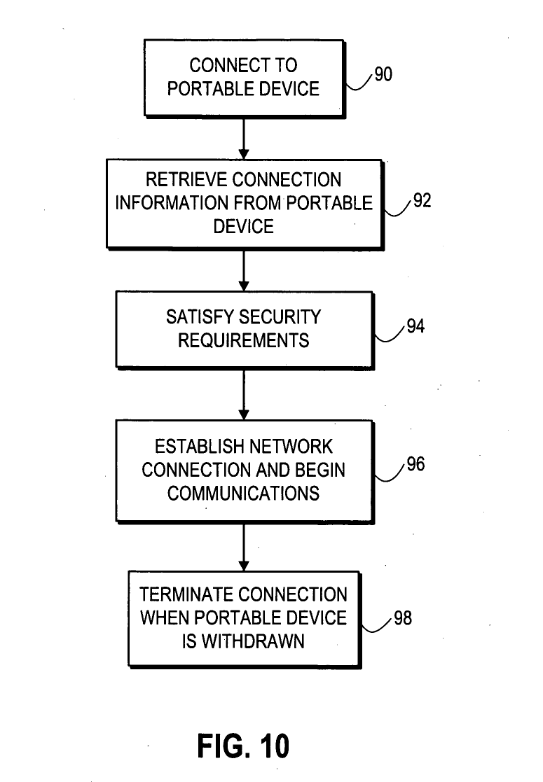

In step 24, remote connecting device 2 accesses the connection information stored in portable device 4. A graphical depiction is shown in FIG. 1. In the present embodiment of the invention, this step is initiated by plugging USB device 4A into connecting device 2. As discussed in more detail below in connection with FIG. 10, connecting device 2 preferably is plug-and-play enabled and portable device 4 preferably is plug-and-play compatible. Accordingly, the mere plugging of portable device 4 into connecting device 2 automatically causes software within connecting device 2 to retrieve the connection information from portable device 4.

The same plug-and-play technology preferably also causes connecting device 2 automatically to establish a network connection to storing device 1 using the retrieved connection information, in step 26. As shown in FIG. 1C, the retrieved information preferably enables connecting device 2 to locate storing device 1 across one or more networks 6 and through one or more firewalls 7, thereby establishing a direct connection 8, which in some embodiments is a one-way connection and in others is a two-way communications link. This step 26 also is described in more detail below in connection with FIG. 10.

Thus, in accordance with the embodiment of the invention described above, portable device 4 may be thought of as a sort of virtual cable. Unlike a conventional physical cable, portable device 4 generally plugs into only a single device at a time and does not itself carry communications between the two devices. Rather, it stores connection information that may be used to create a separate network connection between the two devices. Despite these differences, however, from the user's perspective a virtual cable according to the present invention often will function very similarly to a conventional physical cable. For example, as discussed in more detail below, in one embodiment of the invention the communications link between storing device 1 and connecting device 2 automatically is terminated when portable device 4 is disconnected from connecting device 2.

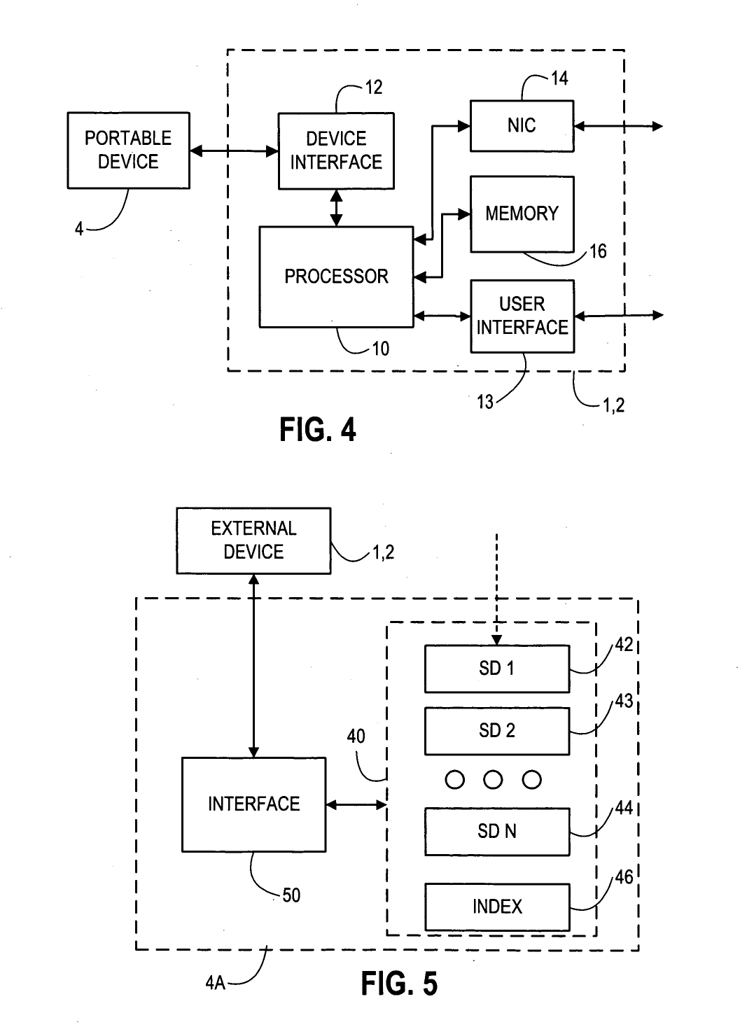

As shown in FIG. 4, each of storing device 1 and connecting device 2 preferably includes a processor 10, which communicates with a device interface 12, a user interface 13, a network interface card 14 and memory 16, together with other elements (including device-specific elements) which are not relevant to the present invention and therefore not illustrated in FIG. 4. Processor 10 controls operation of the device 1,2, typically by retrieving and then executing process steps stored in memory 16.

As described below, user interface 13 allows a user to control operations of the device 1,2, and preferably includes a keypad or keyboard and a display. Network interface card 14 is for communicating across an external network. As such, in different embodiments it comprises, e.g., an Ethernet card, an 802.11 wireless network card and/or a cellular wireless network card.

Device interface 12 communicates with portable electronic device 4 so as to store or retrieve, as the case may be, network connection information. As noted above, in certain embodiments of the invention device interface 12 comprises a physical port, such as a USB port. In alternate embodiments, interface 12 comprises a wireless interface, such as a Bluetooth, infrared or 802.11 interface. In still further embodiments of the invention, device interface 12 comprises a networked device that communicates with processor 10 through network interface card 14. More preferably, device 1,2 is configured so as to be able to use any of its available external interfaces to communicate with portable device 4, thereby accommodating the largest possible range of devices 4. In any event, the communications between device 1,2 and device 4 preferably are short-range. That is, the transfer of information to or from device 4 preferably occurs within close proximity, e.g., less than 5 or 10 feet, and often less than two or three feet, i.e., so as to provide true walk-up capability.

FIG. 5 is a block diagram showing the preferred configuration of the small portable device 4A of FIG. 3. In the present embodiment, device 4A is a relatively simple device comprised of memory 40, having a number of storage locations 42-44 and an index 46, together with a relatively simple interface 50 for allowing an external device 1,2 to store and retrieve information. Preferably, device 4A is capable of storing connection information for a plurality of different storing devices 1. Accordingly, each storage location 42-44 is used for storing the connection information for a different storing device 1. Due to the finite amount of memory 40 within device 4A, new storing device connection information preferably is stored on a first-in-last-out basis, meaning that only the N most recently stored entries are retained, where N is the capacity of device 4A. However, as discussed in more detail below, this technique preferably can be altered if the storing device 1 has adequate functionality and user interface capabilities.

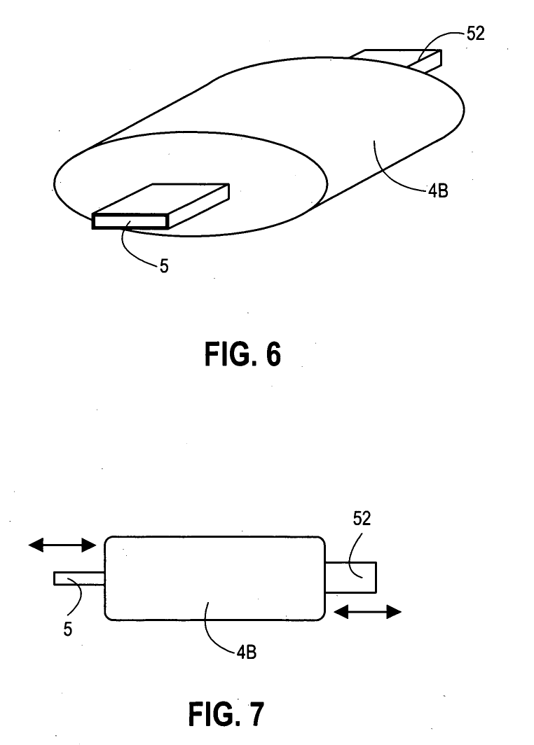

A somewhat modified version of portable device 4A is portable device 4B, shown in FIGS. 6 and 7. Like device 4A, device 4B also is a USB device. However, in addition to male USB connection port 5, device 4B also includes a secondary connection port 52. A variety of different embodiments are possible with respect to connection port 52.

In one embodiment, port 52 is a second male USB connection port that is identical to port 5. Then, for example, port 5 is used to connect to device 1 and port 52 is used to connect to device 2, e.g., both being computers.

In another embodiment, port 52 is a male connection port, but of a different type (e.g., smaller) than port 5. In this embodiment, for example, port 5 is used to connect to one type of device (e.g., a computer) and port 52 is used to connect to another type of device (e.g., a printer).

In a still further embodiment, port 52 is a female USB connection port for accepting another USB device. The provision of port 52 in this embodiment means that the use of device 4B need not reduce the number of available USB ports on the device (e.g., 1,2) into which it is plugged. In addition, the use of such a port 52 can permit the daisy-chaining of multiple portable devices 4, as discussed in more detail below.

Various combinations of the foregoing embodiments also are possible. For example, in one embodiment a device 4B has both male and female ports of a first type (e.g., the male being suited for connecting to a computer) and a male port of a second type (e.g., suitable for connecting to a peripheral) and, therefore, could act as a pass-through if connected to a computer and could also act as a virtual cable between a computer and a peripheral.

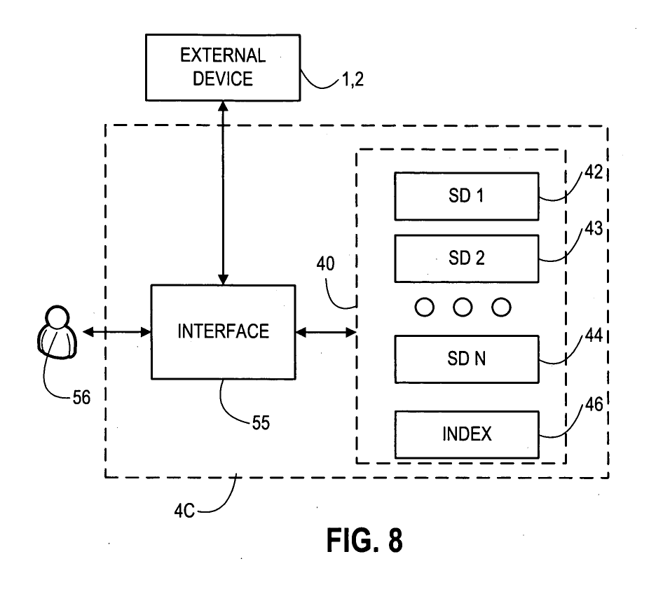

FIG. 8 is a block diagram of a more complex portable device 4C for storing network connection information, according to a still further embodiment of the present invention. In addition to the other components of device 4A, as illustrated in FIG. 5, the interface 55 of device 4C preferably also includes functionality and hardware (e.g., a keypad and a display) for communicating with an end user 56. Thus, device 4C preferably is a general-purpose device that might be characterized as a personal digital assistant (PDA), whether standalone or wireless (e.g., cellular and/or WiFi), such as a Palm-based or a Windows CE-based PDA, or a wireless (e.g., cellular and/or WiFi) telephone. In addition to the user interface 55, such a device typically also will have a general-purpose processor which preferably is programmed to give the user 56 better control than is possible with portable device 4A. Also, portable device 4C typically, although not always, will be capable of establishing a wireless connection to an external device 1,2.

FIG. 9 is a flow diagram for explaining how storing device 1 stores network connection information into portable device 4, according to a representative embodiment of the present invention.

Initially, in step 70 storing device 1 connects to portable device 4. In the preferred embodiment, this step is accomplished by plugging portable device 4 into storing device 1, e.g., using a USB port. If this is the case, then storing device 1 preferably is provided with a plug-and-play driver that immediately recognizes portable device 4 and automatically performs the following steps. However, in alternate embodiments the following steps are instantiated manually, such as by double-clicking an icon or pressing a dedicated button to store the device's connection information.

In still further embodiments, a wireless connection is established between device 1 and device 4. Once again, in sub-embodiments storing device 1 automatically detects portable device 4 and, upon such detection, automatically performs the following steps. In other sub-embodiments, the following steps are instantiated manually.

It is noted that even with plug-and-play capability or other automatic execution capability, for security reasons it often will be desirable to require some form of user confirmation before storing access information onto portable device 4.

In step 72, storing device 1 obtains the connection information that will allow a remote device to connect to it. The various sub-embodiments of the invention implement this step in different ways. Moreover, according to one class of such sub-embodiments, the choice as to which particular sub-embodiment to actually implement is predetermined and programmed into storing device 1. According to an alternate class of sub-embodiments, the user of storing device 1 provides input regarding the variations described below, which input is expressed through user interface 13 on storing device 1.

Preferably, the connection information obtained in this step 72 includes information identifying how to reach storing device 1 from an arbitrary location or, in alternate embodiments, from an arbitrary but constrained location. For instance, in certain embodiments access to storing device 1 is intended to be limited to other devices on the same LAN, e.g., behind the same main firewall. In other embodiments, it is intended that storing device 1 will be accessible over any public network.

Depending upon the particular embodiment, the connection information includes any or all of: the type of device that storing device 1 is, the network configuration, any access limitations, one or more network addresses, the configurations of any firewalls, access information to get through such firewalls, a directory location on storing device 1, or any other information for accessing some desired portion of storing device 1. In addition, or instead, special-purpose access instructions (e.g., in the form of code or pseudo-code) may be included for cases that do not fit within pre-defined configurations.

The type of device indicates whether, for example, storing device 1 is a computer, a printer or a scanner. In addition, if it is a peripheral device this information preferably indicates the manufacturer and specific model.

The network configuration identifies what physical networks can be used to access storing device 1. For example, such physical network information might indicate that storing device 1 is directly accessible over the Internet, that it is accessible over a LAN that is connected to the Internet, that it is accessible by e-mail and/or that it is accessible by dial-in telephone access. In addition, the network configuration information identifies the software configuration for accessing storing device 1. For example, such software configuration information might indicate that storing device 1 is accessible: directly, over a virtual private network (VPN), over a Citrix connection or through a direct-access product such as PC Anywhere.

The information regarding access limitations identifies any prerequisites for being able to connect to storing device 1. For instance, in one embodiment accesses restricted to other devices on the identified LAN. In another, only certain types of connecting devices 2 (e.g., only scanners) are allowed to access storing device 1.

Depending upon the specified network configuration, the connection information is specified as: an Internet protocol (IP) address, a device name (which later, typically, is resolved into an IP address by a domain name server), a telephone number (where dial-in access is supported or where the storing device 1 is accessible over a wireless cellular network), an e-mail address, or any other identification information that is utilized on the corresponding network. With regard to IP-based networks, direct specification of an IP address preferably is used where static IP addresses have been assigned, while specification of a device name preferably is used where IP addresses are assigned dynamically. In certain sub-embodiments, multiple identification information is included, such as where storing device 1 is to be accessed over the Internet and both the identity of the specific device on its local area network (LAN) and the identity of its LAN are to be specified. In such a case, each element of such identification information is specified as an IP address or as a device name.

In many embodiments, the firewall configurations will be implicit in the previously specified network configuration. In others, the firewall configuration is explicitly set forth.

The access information typically specifies parameters (e.g., passwords) for getting through the provided firewalls. For any firewall that it is operated by storing device 1 (typically software-based), this information typically already will be known to storing device 1. For any firewall operating on an external device (e.g., one that protects the entire LAN), storing device 1 typically first will need to obtain such information (either in real-time or previously).

Finally, in certain embodiments it is desirable to provide specific direction to a particular portion of storing device 1. One example is where storing device 1 is a general-purpose computer and it is desired that scanned documents (or other documents transferred from connecting device 2) are to be saved to a particular folder on storing device 1.

Also, in particular embodiments of the invention any or all of the foregoing information is specified differently for different types of connecting devices 2. For instance, a first network path might be specified for computers to connect to storing device 1 via a VPN, a second network path and a “Scanned Documents” folder might be specified for scanners to store scanned documents, and the same second network path but a “Pictures” folder might be specified for a networked camera to use.

The foregoing information generally presumes predefined configurations. However, in certain cases a network and/or firewall configuration is out-of-the-ordinary and, accordingly, not capable of being handled by pre-specified templates. In such cases, storing device 1 preferably stores special-purpose instructions (e.g., in the form of code or pseudo-code) which ultimately will allow the connecting device 2 to navigate the non- standard aspects of the connection.

In step 74, security is applied to the information assembled in step 72. Preferably, this step involves encrypting the information such that it can only be decrypted using a code (e.g., a biometric code or a password) provided by an authorized user. However, in alternate embodiments the information is not encrypted, but such a code must be provided by connecting device 2 to storing device 1 before the connection can be completed; that is, the connection information itself is not changed but rather an internal security setting is made by storing device 1. In still further embodiments, this step 74 may be omitted entirely.

In step 76, the connection information obtained in step 72 (preferably as encrypted in step 74) is stored into portable device 4. In one embodiment of the invention, the information is stored into the first location in memory 40 for portable device 4A or 4C. Alternatively, the memory location may be selected via interface 13 provided on storing device 1. In either event, in embodiments where portable device 4C is utilized, interface 55 preferably can be used by user 56 to alter the priorities of, or otherwise select, the connection information for the various storing devices 1.

In step 78, firewall permissions are set as desired in connection with the access information stored into device 4. For example, as a further security feature, in certain embodiments of the invention the newly created access rights have a limited life, e.g., expiring after a certain period of time or permitting only a one-time access (or a fixed number of connections). For this purpose, temporary or limited-use access codes preferably are established at the firewall.

FIG. 10 is a flow diagram for explaining the functioning of connecting device 2 and, in particular, the establishment of a network connection by connecting device 2, according to a representative embodiment of the present invention.

Initially, in step 90 connecting device 2 connects to portable device 4. In the preferred embodiment, this step is accomplished by plugging portable device 4 into connecting device 2, e.g., using a USB port. If this is the case, then connecting device 2 preferably is provided with a plug-and-play driver that immediately recognizes portable device 4 and automatically performs the following steps. However, in alternate embodiments the following steps are instantiated manually, such as by double-clicking an icon or pressing a dedicated button to begin the execution of the following steps.

In still further embodiments, a wireless connection (e.g., Bluetooth, infrared or 802.11) is established between connecting device 2 and device 4. Once again, in certain sub-embodiments connecting device 2 automatically detects portable device 4 and, upon such detection, automatically performs the following steps. In other sub-embodiments, the following steps are instantiated manually, e.g., using interface 13 on connecting device 2 or using interface 55, in the event that portable device 4C is utilized.

In step 92, connecting device 2 retrieves the connection information from portable device 4. In certain embodiments, portable device 4 is largely passive during this step, functioning primarily as a simple memory device. In one such embodiment, connecting device 2 simply retrieves the connection information from the first storage location 42 in memory 40 of portable device 4. In other embodiments, portable device 4 actively transmits the information to connecting device 2. As to this latter case, assuming that device 4C is utilized and that its stores connection information for multiple different storing devices 1, the user 56 preferably selects the desired storing device 1 from a list provided by interface 55 or from a list provided by an interface on connecting device 2. As noted above, the data transfer is performed wirelessly in certain embodiments and via a hard-wired connection in others.

In still further embodiments, connection information is retrieved for multiple storing devices 1 within portable device 4. For example, where device 4C is utilized the user 56 preferably has the ability to select two or more storing devices 1 from a list displayed on interface 55. Where connecting device 2 as an appropriately configured user interface 13, the user preferably has the ability to select two or more storing devices 1 from the list of entries within a single portable device 4 or from among multiple different portable devices 4. As to this latter case, connecting device 2 preferably scans to identify all portable devices 4 that are either hardwire connected to it or are wirelessly accessible from it and then displays an aggregate list of all storing devices 1 that are available. Finally, where multiple portable devices 4B are utilized and daisy-chained together (e.g., by connecting the port 5 of one to the port 52 of another), or where connecting device 2 has multiple input ports into which multiple portable devices 4 are plugged, connecting device 2 preferably automatically retrieves the connection information from the first storage location 42 in each.

In step 94, any security requirements are satisfied. As noted above, this preferably involves, for example, the user inputting a password, having a fingerprint scanned (e.g., via an interface provided on connecting device 2) for providing some other biometric validation.

In step 96, using the information retrieved in step 92, connecting device 2 establishes a network connection 8 to storing device 1. In this regard, connecting device 2 preferably has installed a driver for portable device 4 that includes a number of predefined network and firewall configurations. For any configuration identified in the retrieved information that matches one of such predefined configurations, the corresponding parameters that were retrieved are used to establish the connection. If, on the other hand, the retrieved information indicates some unique configuration, then the retrieved special instructions preferably are executed by connecting device 2 in order to complete the network connection.

In certain embodiments, the network connection is a simple one-way link that allows data from connecting device 2 to be transferred to storing device 1 or to a particular folder or other location within storing device 1. Even more simply, the network connection may involve a simple e-mail message to storing device 1 that includes such data.

However, in the preferred embodiments of the invention, a two-way link is established between connecting device 2 and storing device 1. That link preferably provides all the capabilities and functionality of a direct cable connection between the two devices. Thus, for example, if the connection is between a computer and a printer the computer can access the printer as if it were connected directly to the computer, sending print jobs to, modifying the configuration of, and receiving status information from the printer. On the other hand, if the connection is between two computers the nature of the connection preferably is identified in the connection information that is stored in portable device 4. The computer-to-computer connections preferably include: LAN-type access (e.g., limited access to one or more folders or other resources that currently are designated as being shared by storing device 1), a VPN connection, or a Citrix connection. If LAN-type access is designated and one or more of the shared resources is password protected, then in certain sub-embodiments the password information is retrieved from portable device 4 and in other sub-embodiments the password information must be input manually by the user once the connection is established.

Also, as indicated above, in certain embodiments the nature of the connection that is established differs depending upon the type of connecting device 2. In one specific embodiment, the connection instructions specify a VPN connection for connecting devices 2 that are computers and specify a direct link to a specific folder for connecting devices 2 that are scanners.

In step 98, the connection is terminated when portable device 4 is physically withdrawn from connecting device 2 or, if portable device 4C is utilized, when the user 56 terminates the session through interface 55 (e.g., by clicking a “disconnect” button). By implementing this step 98, portable device 4 functions as a sort of true virtual cable; disconnecting it terminates the communications between the devices 1 and 2. In alternate embodiments, this step 98 is omitted, and the connection persists even after such withdrawal, until eventually terminated by one of the two devices 1 and 2.

It is noted that if temporary or limited-use firewall permissions have been set in step 78, then even if connecting device 2 retains any of the connection information within its internal memory, its ability to subsequently reconnect to storing device 1 is inhibited. In such a case, preferably either or both of connecting device 2 and portable device 4 includes embedded functionality for automatically deleting the connection information from the location 42 in the memory 40 of portable device 4 for a particular storing device 1 when such information has expired. As a result, the next connecting device 2 will attempt to connect to the storing device 1 whose information is in storage location 43 or, if user-interface functionality is provided that allows the user to select the storing device 1 to connect to from a list of available devices, the expired information simply is no longer present in the list.

System Environment.

Generally speaking, nearly all of the methods and techniques described herein can be practiced with the use of a general-purpose computer system. Such a computer typically will include, for example, at least some of the following components interconnected with each other, e.g., via a common bus: one or more central processing units (CPUs), read-only memory (ROM), random access memory (RAM), input/output software and/or circuitry for interfacing with other devices and for connecting to one or more networks (which in turn, in many embodiments of the invention, connect to the Internet or to any other networks), a display (such as a cathode ray tube display, a liquid crystal display, an organic light-emitting display, a polymeric light-emitting display or any other thin-film display), other output devices (such as one or more speakers, a headphone set and/or a printer), one or more input devices (such as a mouse, touchpad, tablet, touch-sensitive display or other pointing device; a keyboard, a microphone and/or a scanner), a mass storage unit (such as a hard disk drive), a real-time clock, a removable storage read/write device (such as for reading from and/or writing to RAM, a magnetic disk, a magnetic tape, an opto-magnetic disk, an optical disk, or the like), and a modem (which also preferably connect to the Internet or to any other computer network via a dial-up connection). In operation, the process steps to implement the above methods, to the extent performed by such a general-purpose computer, typically initially will be stored in mass storage (e.g., the hard disk), are downloaded into RAM and then executed by the CPU out of RAM.

Suitable computers for use in implementing the present invention may be obtained from various vendors. Various types of computers, however, may be used depending upon the size and complexity of the tasks. Suitable computers include mainframe computers, multiprocessor computers, workstations, personal computers, and even smaller computers such as PDAs, wireless telephones or any other appliance or device, whether stand-alone, hard-wired into a network or wirelessly connected to a network. In addition, although a general-purpose computer system has been described above, in alternate embodiments a special-purpose computer instead (or in addition) is used. In particular, any of the functionality described above can be implemented in software, hardware, firmware or any combination of these, with the particular implementation being selected based on known engineering tradeoffs. In this regard, it is noted that the functionality described above primarily is implemented through fixed logical steps and therefore can be accomplished through programming (e.g., software or firmware), an appropriate arrangement of logic components (hardware) or any combination of the two, as is well-known in the art.

It should be understood that the present invention also relates to machine-readable media on which are stored program instructions for performing the methods of this invention. Such media include, by way of example, magnetic disks, magnetic tape, optically readable media such as CD ROMs and DVD ROMs, semiconductor memory such as PCMCIA cards, etc. In each case, the medium may take the form of a portable item such as a small disk, diskette, cassette, etc., or it may take the form of a relatively larger or immobile item such as a hard disk drive, ROM or RAM provided in a computer.

The foregoing description primarily emphasizes electronic computers. However, it should be understood that any other type of computer instead may be used, such as a computer utilizing any combination of electronic, optical, biological and/or chemical processing.

Additional Considerations.

It should be noted that, in accordance with the present invention, a user preferably has the ability to connect a portable device 4 to other devices 1 and/or 2 in any of a variety of different sequences, depending upon the desired results. For example, a user might initially connect portable device 4 to his or her computer to obtain the computer's connection information, then carry portable device 4 to a scanner, plug it in, and then hit “Scan” to send the scanned document back to his or her computer. Alternatively, a user might connect portable device 4 to a printer to obtain its connection information, then walk to his or her computer, plug in device 4, and then print to the printer. Still further, a user might initially connect portable device 4 to his or her computer to obtain its connection information, then mail the device 4 to another individual (or electronically transmit the information to such individual for loading onto that individual's own portable device 4); the remote individual then connects the subject portable device 4 to a printer, whereupon the user may print from his or her computer and the output appears on this remote printer.

As indicated above, a variety of different portable devices 4 are contemplated to be used in the present invention, including simple memory devices (e.g., USB memory devices) as well as more intelligent devices, such as wireless telephones and PDAs.

Particularly with respect to simple or unintelligent devices, it often will be desirable that the device itself has a readable identification code (e.g., a USB plug-and-play identification code) that designates the portable device 4 as a “virtual cable”. As a result, a storing device 1 or a connecting device 2 preferably automatically will recognize the portable device 4 and automatically (with or without user action) store or retrieve network connection information from portable device 4. In addition, the network connection information preferably is stored in portable device 4 in a standard format so that connecting device 2 will be able to interpret it automatically using pre-specified decoding instructions. No specific format need be used, provided that storing device 1 and connecting device 2 (together with portable device 4, if it is an intelligent device) are all aware of the format and are programmed to operate on data in such format.

Where one or both of devices 1 and 2 connects wirelessly with portable device 4, it generally is preferable for the applicable device 1 and/or 2 to periodically (either automatically or upon manual user designation) scan for any devices 4 that are within their wireless range. Then, if any are found the device's user interface preferably displays information regarding the subject device(s) 4 and/or, with respect to scanning by connecting devices 2, regarding the storing devices 1 which are available for connection.

In embodiments where portable device 4 is intelligent, portable device 4 preferably also is configured to periodically scan for compatible devices 1 and/or 2 or, alternatively, is configured to allow the user to request such a scan when desired. In either such case, a list of available devices preferably is displayed to the user.

Any of the foregoing scanning may be accomplished by broadcasting a particular code and then listening for an appropriate response code. Once the devices identify each other, they preferably execute their respective compatible protocols for storing network connection information into the portable device 4 or retrieving such information from the portable device 4. In embodiments where wireless communications are utilized, it generally is preferable to require some user designation (e.g. through the user interface of portable device 4) before network connection information is transmitted to a connecting device 2.

It should be understood that, with respect to the discussion set forth above, any single device may function at various times as a storing device 1 and/or as a connecting device 2.

The techniques of the present invention apply to setting up any of a variety of different types of network connections. Preferably, the resulting network connection is bidirectional, allowing the two devices to send information (e.g., data to be stored or printed, status information, configuration information and settings, etc.) back and forth. According to different embodiments, any or all of the following network connections are established: a VPN network, the creation of a network drive for storing documents onto another device (e.g., that device's hard disk), a remote access connection (e.g., Citrix™ or PC Anywhere™ ). In some of the preferred embodiments of the invention, the storing device 1 is a peripheral device, such as a printer, and the connecting device 2 is a general-purpose computer that installs storing device 1 as a currently active and controllable peripheral device, e.g., so that device 1 is accessible just like any other printer that is available to device 2. In such a case, the user of device 2 preferably has the ability to configure device 1 and to send jobs to it.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method for transferring network connection information from one network device to another, comprising:
physically transporting a handheld electronic device to a first network device that communicates over a network;
transferring network connection information from the first network device into the handheld electronic device, wherein the network connection information permits a remote device to establish a connection to said network device over the network;
physically transporting the handheld electronic device to a second network device; and
transferring the network connection information from the handheld electronic device into the second network device,
wherein the second network device is configured to automatically establish a connection to the first network device using the network connection information.

2. A method according to claim 1, wherein the second network device is configured to automatically detect the handheld electronic device.

3. A method according to claim 1, wherein the handheld electronic device physically couples to the first network device and to the second network device for transferring the network connection information.

4. A method according to claim 1, wherein the handheld electronic device communicates wirelessly with at least one of the first network device and the second network device for transferring the network connection information.

5. A method according to claim 4, wherein the wireless communication comprises at least one of: Bluetooth, infrared or 802.11.

6. A method according to claim 1, wherein a user action is required to initiate the transfer of the network connection information from the handheld electronic device to the second network device.

7. A method according to claim 1, wherein the handheld electronic device also stores second network connection information for permitting connection to a third network device.

8. A method according to claim 7, wherein a user selects which of the network connection information or the second network connection information to transfer to the second network device.

9. A method according to claim 1, wherein the second network device comprises a general-purpose computer, the first network device comprises a peripheral device, and the connection established by the second network device comprises installing the first network device as a currently active and controllable peripheral device on the second network device.

10. A method according to claim 1, wherein the connection established by the second network device comprises a two-way communication link between the first network device and the second network device.

11. A network device for establishing a network connection, comprising:
a network interface configured to communicate over a network; and
a device interface configured to automatically detect a portable device having pre-specified criteria,
wherein after said detection, the network device receives from the portable device network connection information for connecting to a remote device that is accessible over the network and then establishes a connection to the remote device over the network using the retrieved network connection information.

12. A network device according to claim 11, wherein the connection comprises a communication channel that permits bidirectional communication between the network device and the remote device.

13. A network device according to claim 11, wherein the device interface comprises a physical port into which the portable device plugs.

14. A network device according to claim 13, wherein the connection to the remote device automatically is terminated when the portable device is unplugged from the physical port.

15. A network device according to claim 13, wherein the network connection information indicates whether to terminate the connection when the portable device is unplugged from the physical port.

16. A network device according to claim 13, wherein the connection automatically is established when the portable device is plugged into the physical port.

17. A network device according to claim 13, wherein the device interface is a universal serial bus (USB) interface.

18. A network device according to claim 11, wherein the device interface uses plug-and-play technology to automatically recognize the portable device, and then to automatically retrieve the network connection information and automatically establish the connection.

19. A network device according to claim 11, wherein the device interface comprises a wireless link.

20. A network device according to claim 11, wherein the network connection information includes information required to get through a firewall.

21. A network device according to claim 11, wherein the network connection information identifies a storage location on the remote device for storing data provided by said network device.

22. A network device according to claim 11, wherein the network connection information also specifies how to connect to a second remote device, and wherein the network device also establishes a network connection with the second remote device, via said network interface, by using the network connection information.

23. A network device according to claim 11, wherein the network interface is configured to communicate over a wireless network.

24. A network device according to claim 11, further comprising a processor configured to decrypt the network connection information based on information provided by a user.

25. A network device according to claim 11, wherein said network device comprises a general-purpose computer.

26. A network device according to claim 11, wherein said network device comprises at least one of a printer or a scanner.

27. A network device for storing network connection information, comprising:
a network interface configured to communicate over a network; and
a device interface configured to automatically detect a portable device having pre-specified criteria,
wherein upon said detection, the network device automatically stores into said portable device network connection information for permitting a remote device to establish a connection to said network device over the network.

28. A network device according to claim 27, wherein the device interface automatically detects the portable device upon physically connecting to the portable device.

29. A network device according to claim 28, wherein the device interface comprises a universal serial bus (USB) port.

30. A network device according to claim 27, wherein the device interface automatically detects the portable device by sending a series of wireless transmissions and listening for an expected response protocol.

31. A network device according to claim 27, wherein the wireless transmissions are made via infrared, Bluetooth or 802.11.

32. A network device according to claim 27, wherein said network device comprises at least one of a printer or a scanner.

33. A network device according to claim 27, further comprising a user interface, wherein a designation via the user interface is required before the network device automatically stores the network connection information into said portable device.

34. A network device according to claim 33, wherein upon detection of the portable device, the user interface automatically is displayed to a user.

35. A network device according to claim 27, wherein the network connection information includes information required to get through a firewall.

36. A network device according to claim 35, further comprising a user interface that permits a user to configure a type of limited access through the firewall that will be permitted with the network connection information.

37. A network device according to claim 27, wherein the network connection information identifies a storage location on the network device for storing data provided by said remote device.

38. A network device according to claim 27, wherein the network connection information is stored into the portable device in a standard format for retrieval by any of a plurality of remote network devices that are configured to use the network connection information to establish the network connection.

39. A portable electronic device for transferring network connection information from one network device to another, comprising:
a device interface configured to communicate with external electronic devices;
a user interface for bidirectional communication with a user;
memory for storing computer-executable process steps;
a processor for executing the computer-executable process steps; and
a handheld chassis enclosing the device interface, the user interface, the memory and the processor,
wherein the computer-executable process steps include steps to identify external electronic devices that are executing compatible protocols for exchanging network connection information, and to permit a user to control at least one of the receipt, storage and transmission of the network connection information through the user interface, and
wherein the compatible protocols include formatting of the network connection information that permits a first external electronic device to use the network connection information to automatically establish a network connection to a second external electronic device to which the network connection information pertains.

40. A portable device according to claim 39, wherein the device interface comprises wireless communication capability.

41. A portable device according to claim 40, wherein the computer-executable process steps further include steps to use the device interface to scan for, and then display on the user interface, a list of the external electronic devices that are executing compatible protocols for exchanging network connection information within wireless range of the device interface.

42. A portable device according to claim 39, wherein the user is required to designate release of the network connection information, via the user interface, before the network connection information is transmitted to one of the external electronic devices.

43. A portable device for storing network communication information, comprising:
a device interface for communicating with external electronic devices;
a memory location storing an identification code that designates the portable device as storing network connection information in a pre-specified standard format that permits a compatible receiving electronic device to automatically retrieve the network connection information and establish a network connection to a second electronic device to which the network connection information pertains.

44. A portable device according to claim 43, wherein the device interface comprises a physical connection port.

45. A portable device according to claim 43, wherein the device interface comprises a universal serial bus (USB) interface.

46. A portable device according to claim 43, wherein the identification code comprises a plug-and-play identification code.
